(19) United States
(12) Patent Application Publication
(10) Pub. No.: US 2009/0209159 A1
(43) Pub. Date: Aug. 20, 2009

(54) TOUGHENED BINDER COMPOSITIONS FOR USE IN ADVANCED PROCESSES

(75) Inventors: Wei Helen Li, San Ramon, CA (US); Stanley L. Lehmann, Martinez, CA (US)

Correspondence Address: LOCTITE CORPORATION, 1001 TROUT BROOK CROSSING, ROCKY HILL, CT, 06067, US

(73) Assignee: Henkel Corporation, Rocky Hill, CT (US)

(21) Appl. No.: 12/434,105

(22) Filed: May 1, 2009

Related U.S. Application Data
(63) Continuation of application No. PCT/US2007/024193, filed on Nov. 19, 2007.
(60) Provisional application No. 60/860,255, filed on Nov. 21, 2006.

(51) Int. Cl. B32B 5/26; B32B 5/16; B29C 70/00

(52) U.S. Cl. 442/381; 442/393; 264/258; 264/101

(57) ABSTRACT

Toughened binder compositions are useful with performs that will be infused with a matrix resin in advanced processes, such as resin transfer molding, vacuum assisted transfer molding and resin film infusion, to form composites and their use in such advanced processes form the basis of the present invention.

### BACKGROUND OF THE INVENTION

1. Field of the Invention

Toughened binder compositions are useful with preforms that will be infused with a matrix resin in advanced processes, such as resin transfer molding, vacuum assisted transfer molding and resin film infusion, to form composites and their use in such advanced processes form the basis of the present invention.

2. Brief Description of Related Technology

Epoxy resins with various hardeners have been used extensively in the aerospace industry, both as adhesives and as matrix resins for use in prepreg assembly with a variety of substrates.

Blends of epoxy resins and benzoxazines are known. See e.g. U.S. Pat. Nos. 4,607,091 (Schreiber), 5,021,484 (Schreiber), 5,200,452 (Schreiber), and 5,445,911 (Schreiber). These blends appear to be potentially useful in the electronics industry as the epoxy resins can reduce the melt viscosity of benzoxazines allowing for the use of higher filler loading while maintaining a processable viscosity. However, epoxy resins oftentimes undesirably increase the temperature at which benzoxazines polymerize.

Ternary blends of epoxy resins, benzoxazines and phenolic resins are also known. See U.S. Pat. No. 6,207,786 (Ishida), and S. Rimdusit and H. Ishida, “Development of new class of electronic packaging materials based on ternary system of benzoxazine, epoxy, and phenolic resin,” Polymer, 41, 7941-49 (2000).

Resin transfer molding (“RTM”) is a process by which a resin—conventionally and predominately, epoxy-based resin systems and maleimide-based systems—is pumped at low viscosities and under pressure into a closed mold die set containing a preform of dry fabric. The resin infuses into the preform to make a fiber-reinforced composite article. The RTM process can be used to produce at low cost composite parts that are complex in shape. These parts typically require continuous fiber reinforcement along with inside mold line and outside mold line controlled surfaces.

Fiber-reinforced composite articles may be manufactured from vacuum assisted resin transfer molding (“VaRTM”), like RTM. In contrast to RTM, VaRTM employs a bag instead of a solid mold on top and places the system under a vacuum to assist the resin infusion process.

Resin film infusion (“RFI”), like RTM, infuses a resin into a preform placed in a mold. Here, however, the resin is in the form of a film, which is placed in the mold together with the preform. U.S. Pat. No. 5,902,535 speaks to RFI molds and processes, and is expressly incorporated herein by reference.

The matrix resin used in the RTM and VaRTM advanced possesses a low injection viscosity to allow complete wetting and infusion of the preform.

Bismaleimide-based resins for RTM and RFI processes are known, and examples of which are described in U.S. Pat. Nos. 5,955,566 and 6,313,248.

And, two component epoxy resin compositions have been used, where the epoxy resin and the hardener components are combined immediately prior to use. One-component epoxy resin compositions oftentimes must be stored at controlled low temperatures to prevent premature cross-linking reactions and to extend storage life. Otherwise, the viscosities of such one-component epoxy resin compositions would build far too quickly, thus rendering their working life unsuitable (or at least not desirable) from a commercial standpoint.

Oftentimes, conventionally, one would use a binder composition to maintain the plies in place. Ordinarily, the binder composition may be one that is epoxy based. Alternatively, or in addition, one may stitch together the plies to maintain the plies in place. When using the binder composition, one would choose a thermoset, such as an epoxy, to bind the plies because a thermoplastic would have little to no binding capability.

In addition to binder compositions, more frequently one would use a thermoplastics to toughen a composite by adding the thermoplastics to a matrix resin. Thermoplastics are used instead of thermosets because thermosets would have little to no toughening capability.

Notwithstanding the state of the technology, there is a need for toughened binder compositions to be used with preforms in these advanced processes, particularly a resin system with improved performance properties. More specifically, it would be desirable to provide a binder composition with toughening properties having the ability to be processed at a temperature to optimize the ultimate toughness and binding properties, without compromising either property or its ability to be processed in advanced processes such as RTM, VaRTM, RFI, or prepregging.

### SUMMARY OF THE INVENTION

The present invention relates to a composition of matter comprising:
a. a thermosetting matrix resin; and
b. a preform comprising a plurality of fabric plies or unidirectional plies disposed between which is a toughening binder composition comprising the combination of a thermosetting resin and a thermoplastic resin.

The thermosetting resin has a melting point that is greater than the temperature at which the thermosetting matrix resin infuses the preform and is less than the cure temperature of the thermosetting resin matrix. In addition, the thermoplastic resin has a Tg that is equal to or greater than the melting point of the thermosetting resin.

In connection with a resin transfer molding process, the present invention provides a method whose steps comprise:

(a) providing a heat curable composition into a closed mold containing a preform comprising a plurality of fabric plies or unidirectional plies disposed between which is a toughening binder composition comprising the combination of a thermosetting resin and a thermoplastic resin;

(b) exposing the interior of the mold to a first elevated temperature and elevated pressure sufficient to wet the preform with the heat curable composition; and

(c) curing the heat curable composition-impregnated preform within the mold at a second elevated temperature to form a resin transfer molded product, where the heat curable composition comprises (i) a benzoxazine component.

The thermosetting resin has a melting point that is greater than the temperature at which the thermosetting matrix resin infuses the preform and is less than the cure temperature of the thermosetting resin matrix. The thermoplastic resin has a Tg that is equal to or greater than the melting point of the thermosetting resin.

In connection with a vacuum assisted resin transfer molding process, the present invention provides a method whose steps comprise:

(a) providing a preform into a mold, where the preform comprises a plurality of fabric plies or unidirectional plies disposed between which is a toughening binder composition comprising the combination of a thermosetting resin and a thermoplastic resin;

(b) providing a heat curable composition into the mold under a first elevated temperature and under vacuum for a time sufficient to allow the composition to wet the preform; and

(c) exposing the mold containing the composition wetted-preform to a second elevated temperature while under vacuum sufficient to cure the heat curable composition-wetted preform within the mold to form a resin transfer molded product, where the heat curable composition comprises (i) a benzoxazine component.

The thermosetting resin has a melting point that is greater than the temperature at which the thermosetting matrix resin infuses the preform and is less than the cure temperature of the thermosetting resin matrix. The thermoplastic resin has a Tg that is equal to or greater than the melting point of the thermosetting resin.

In connection with a resin film infusion process, the present invention provides a method whose steps comprise:

(a) providing a preform into a closed mold containing a heat curable composition in film form, where the preform comprises a plurality of fabric plies or unidirectional plies disposed between which is a toughening binder composition comprising the combination of a thermosetting resin and a thermoplastic resin;

(b) exposing the interior of the mold to a first elevated temperature and optionally vacuum, while the exterior of the mold is exposed to an elevated pressure, for a time sufficient to infuse the preform with the heat curable composition; and

(c) curing the heat curable composition-infused preform within the mold at a second elevated temperature to form a resin transfer molded product.

In each of the processes, the heat curable composition comprises a benzoxazine component.

In addition, in each of the processes, the thermosetting resin has a melting point that is greater than the temperature at which the thermosetting matrix resin infuses the preform and is less than the cure temperature of the thermosetting resin matrix. The thermoplastic resin has a Tg that is equal to or greater than the melting point of the thermosetting resin.

The present invention will be more fully understood by a reading of the following detailed description of the invention.

### DETAILED DESCRIPTION OF THE INVENTION

As noted above, the present invention relates to a composition of matter comprising:
a. a thermosetting matrix resin; and
b. a preform comprising a plurality of fabric plies or unidirectional plies disposed between which is a toughening binder composition comprising the combination of a thermosetting resin and a thermoplastic resin.

The inventive composition of matter may be formed in advanced processes such as RTM, VaRTM, RFI or prepregging.

In connection with a resin transfer molding process, the present invention provides a method whose steps comprise:

(a) providing a heat curable composition into a closed mold containing a preform comprising a plurality of fabric plies or unidirectional plies disposed between which is a toughening binder composition comprising the combination of a thermosetting resin and a thermoplastic resin;

(b) exposing the interior of the mold to a first elevated temperature and elevated pressure sufficient to wet the preform with the heat curable composition; and

(c) curing the heat curable composition-impregnated preform within the mold at a second elevated temperature to form a resin transfer molded product.

In connection with a vacuum assisted resin transfer molding process, the present invention provides a method whose steps comprise:

(a) providing a preform into a mold, where the preform comprises a plurality of fabric plies or unidirectional plies disposed between which is a toughening binder composition comprising the combination of a thermosetting resin and a thermoplastic resin;

(b) providing a heat curable composition into the mold under a first elevated temperature and under vacuum for a time sufficient to allow the composition to wet the preform; and

(c) exposing the mold containing the composition wetted-preform to a second elevated temperature while under vacuum sufficient to cure the heat curable composition-wetted preform within the mold to form a resin transfer molded product.

In connection with a resin film infusion process, the present invention provides a method whose steps comprise:

(a) providing a preform into a closed mold containing a heat curable composition in film form, where the preform comprises a plurality of fabric plies or unidirectional plies disposed between which is a toughening binder composition comprising the combination of a thermosetting resin and a thermoplastic resin;

(b) exposing the interior of the mold to a first elevated temperature and optionally vacuum, while the exterior of the mold is exposed to an elevated pressure, for a time sufficient to infuse the preform with the heat curable composition; and

(c) curing the heat curable composition-infused preform within the mold at a second elevated temperature to form a resin transfer molded product.

In each of these processes, the heat curable composition is a thermosetting matrix resin comprising (i) a benzoxazine component. (Heat curable composition and thermosetting matrix resin are used herein interchangeably.)

In addition in each of these processes, the thermosetting resin has a melting point that is greater than the temperature at which the thermosetting matrix resin infuses the preform and is less than the cure temperature of the thermosetting resin matrix. The thermoplastic resin has a Tg that is equal to or greater than the melting point of the thermosetting resin.

Of course, the invention provides products, such as RTM, VaRTM and RFI products, made by these advanced processes.

Complex three dimensional part geometries may be molded in the advanced processes described herein as a single piece unit. RFI, for instance, is particularly useful for molding large composite parts, as it defines the entire geometry of the part in a single process cycle, thereby eliminating any subsequent assembly or bonding processes. In the aerospace industry, for one, it is not uncommon for parts to be up to 100 feet in length and up to 30 feet in width, located on lofted surfaces with integral stiffening and attachment details. Using these advanced processes to form such large parts, assembly and tooling costs normally associated with a mechanically fastened or bonded structure may be reduced. In addition, narrow engineering tolerances may be realized using these advanced processes to enable assembly of a large aircraft structure with minimal shimming, typically associated with non-monolithic components constructed from sub-assemblies.

In an RFI process, a resin film molding tool is ordinarily used, which includes an outer mold tool, which includes a facing sheet supported by a support structure. A resin film prepared from a benzoxazine is positioned on the facing sheet, and a preform is positioned on the resin film. The preform is designed in the shape of a desired article to be fabricated from compositing materials, such as fibers made from carbon, aramid, ceramic and the like. The preform may include a preform skin, as described in U.S. Pat. No. 5,281,368, the disclosure of which is hereby expressly incorporated herein by reference.

RTM systems are well known, such as those described in U.S. Pat. Nos. 5,369,192, 5,567,499, 5,677,048, 5,851,336, and 6,156,146, which are incorporated herein by reference. VaRTM systems are also well known, such as those described in U.S. Pat. Nos. 5,315,462, 5,480,603 and 5,439,635, which also expressly are incorporated herein by reference.

RTM systems produce composite articles from resin impregnated preforms. Here, the preform together with the toughening binder composition disposed thereon is placed in a cavity mold. A thermosetting matrix resin, such as a benzoxazine-containing heat curable composition, is then injected into the mold to wet and infuse the fibers of the preform. In an RTM process, the thermosetting matrix resin is introduced into the cavity mold under pressure and is cured under elevated temperature. The resulting solid article may be subjected to post curing operations to produce a final composite article, though this is not required.

Thus, with the RTM process, the preform is placed within the mold, the mold is then closed and the thermosetting matrix resin is introduced, and allowed to infuse the preform. This introduction may occur under mildly elevated temperature conditions to improve flow characteristics of the benzoxazine-containing heat curable composition for a time sufficient to allow wetting of the preform.

The interior of the mold is then heated to, and maintained at, a temperature (ordinarily within the range of 250° F. to 350° F.) sufficient to cure the benzoxazine-containing heat curable composition, for a time sufficient to cure the heat curable composition. This time is ordinarily within the 90 to 180 minute range, depending of course on the precise constituents of the heat curable composition. After cure is complete, the temperature of the mold is allowed to cool and the RTM product made by the process is removed.

In a VaRTM process, after providing the preform together with the toughening binder composition disposed thereon, a dispersing medium may be disposed thereover. The dispersing medium is positioned on the surface of prefrom in an envelope within the mold. The dispersing medium is oftentimes a flexible sheet or liner. The vacuum is applied to collapse the dispersing medium against the preform and assist in the introduction of the benzoxazine-containing heat curable composition into the mold to wet and infuse the preform.

The benzoxazine-containing heat curable composition is injected into the mold, and allowed to wet and infuse the preform. This injection may again occur under a mildly elevated temperature, this time through and under vacuum for a period of time sufficient to allow the composition to wet and infuse the preform.

The benzoxazine-containing heat curable composition is introduced under vacuum into the envelope to wet and infuse the preform. The vacuum is applied to the interior of the envelope via a vacuum line to collapse the flexible sheet against the preform. The vacuum draws the benzoxazine-containing heat curable composition through the preform and helps to avoid the formation of air bubbles or voids in the finished article. The benzoxazine-containing heat curable composition cures while being subjected to the vacuum.

The mold is then exposed to an elevated temperature, ordinarily within the range at 250° F. to 350° F., while remaining under vacuum, for a period of time sufficient to cure the heat curable composition-wetted preform within the mold. This time period again is ordinarily within the 90 to 180 minute range. The vacuum also draws off any fumes produced during the curing process. After cure is complete, the temperature of the mold is allowed to cool and the VaRTM product made by the process is removed.

For these advanced processes, the benzoxazine-containing heat curable composition has a viscosity in the range of 10 to 5000 cps at resin injection temperature (10 to 500 cps for RTM or VaRTM; 100-5000 cps for RFI). In addition, the time within which the viscosity of the heat curable composition increases by 100% under the process conditions is in the range of 1 to 10 hours. The injection temperature of the benzoxazine-containing heat curable composition (or thermosetting matrix resin) is ordinarily in the range of about 90° C. to about 110° C.

The resulting solid article so made by the VaRTM process may be subjected to post curing operations to produce a final composite article.

The first step in either of the RTM/VaRTM processes is thus to fabricate a fiber preform in the shape of the desired article. The preform generally includes a number of fabric layers or plies made from these fibers that impart the desired reinforcing properties to a resulting composite article. Once the fiber preform has been fabricated together with the toughening binder composition disposed thereon, the preform is placed in a mold.

The benzoxazine of the heat curable composition or thermosetting matrix resin may be embraced by the following structures:

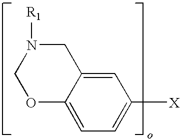

where o is 1-4, X is a direct bond (when o is 2), alkyl (when o is 1), alkylene (when o is 2-4), carbonyl (when o is 2), thiol (when o is 1), thioether (when o is 2), sulfoxide (when o is 2), and sulfone (when o is 2), and R₁ is alkyl, such as methyl, ethyl, propyls and butyls, or

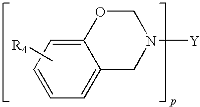

where p is 2, Y is selected from biphenyl (when p is 2), diphenyl methane (when p is 2), diphenyl isopropane (when p is 2), diphenyl sulfide (when p is 2), diphenyl sulfoxide (when p is 2), diphenyl sulfone (when p is 2), and diphenyl ketone (when p is 2), and R₄ is selected from hydrogen, halogen, alkyl and alkenyl.

In a more specific representation, the benzoxazine component is embraced by one or more of

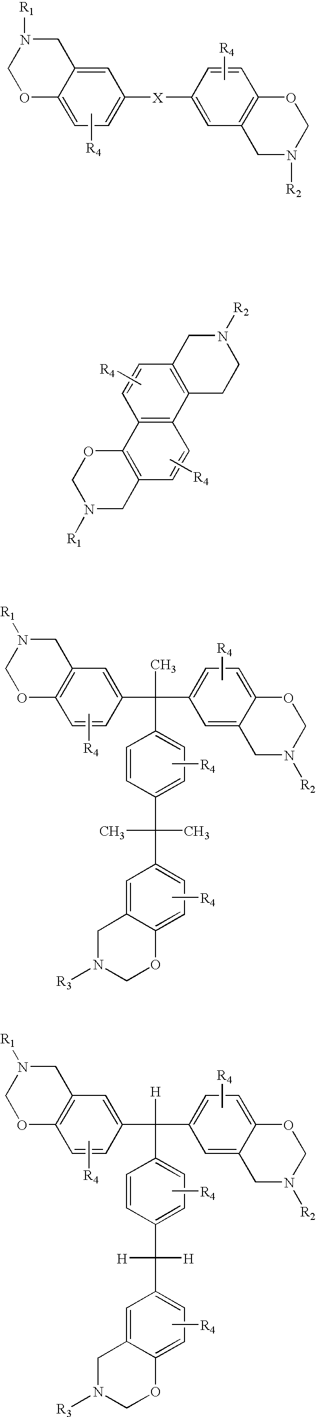

where X is selected from a direct bond, CH₂, C(CH₃)₂, C═O, S, S═O and O═S═O, and R₁, R₂, R₃ and R₄ are the same or different and are selected from hydrogen, alkyl, alkenyl and aryl.

In a more particular representation, the benzoxazine component is embraced by

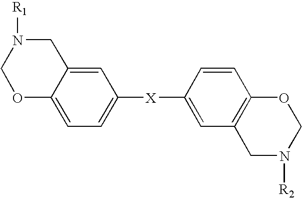

where X is selected from a direct bond, CH₂, C(CH₃)₂, C═O, S═O and O═S═O, S, and R₁ and R₂ are the same or different and are selected from methyl, ethyl, propyls and butyls.

In yet a more specific representation, the benzoxazine component is embraced by

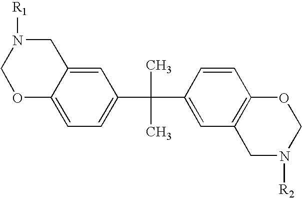

where R₁ and R₂ are the same or different and are selected from methyl, ethyl, propyls and butyls, though in a particularly desirable embodiment R₁ and R₂ are each methyl.

Specific examples of benzoxazines useful herein include one or more of

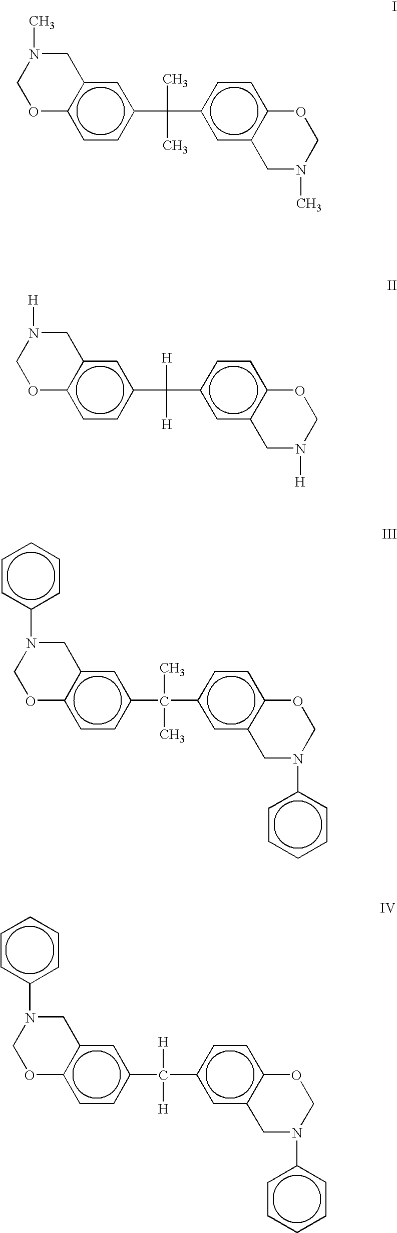

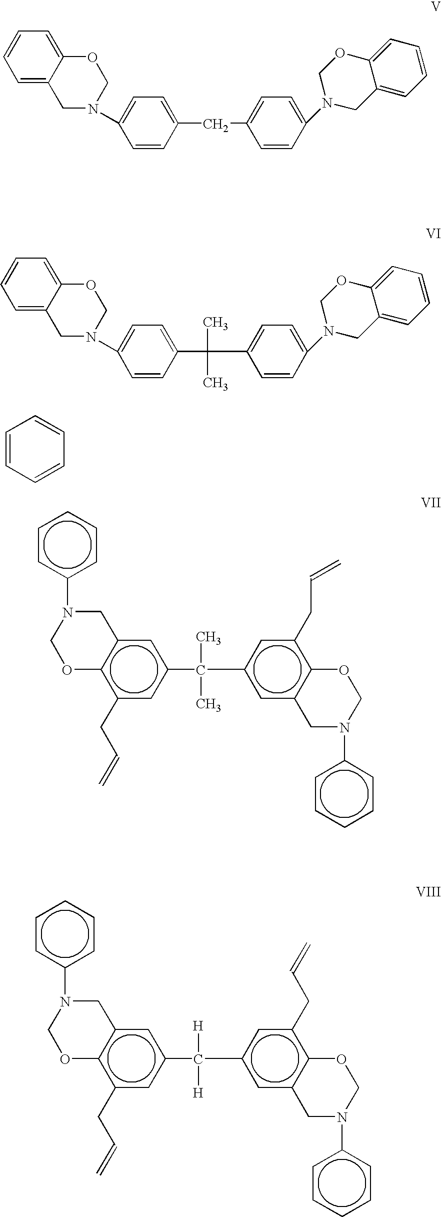

The benzoxazine component may include the combination of multifunctional benzoxazines and monofunctional benzoxazines. Examples of monofunctional benzoxazines may be embraced by the following structure:

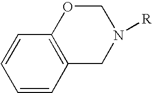

where R is alkyl, such as methyl, ethyl, propyls and butyls.

In one aspect of the toughening binder composition, the thermosetting resin may be an epoxy resin. Suitable epoxy resins include any of a large number of polyepoxides having at least about two 1,2-epoxy groups per molecule and which have a melting point greater than the injection temperature of the thermosetting matrix resin. Thus, some of the polyepoxides may be saturated, unsaturated, cyclic or acyclic, aliphatic, alicyclic, aromatic or heterocyclic polyepoxide compounds. Examples of suitable polyepoxides include the polyglycidyl ethers, which are prepared by reaction of epichlorohydrin or epibromohydrin with a polyphenol in the presence of alkali. Suitable polyphenols therefor are, for example, resorcinol, pyrocatechol, hydroquinone, bisphenol A (bis(4-hydroxyphenyl)-2,2-propane), bisphenol F (bis(4-hydroxyphenyl)methane), bisphenol S, biphenol, bis(4-hydroxyphenyl)-1,1-isobutane, 4,4′-dihydroxybenzophenone, bis(4-hydroxyphenyl)-1,1-ethane, and 1,5-hydroxynaphthalene. Other suitable polyphenols as the basis for the polyglycidyl ethers are the known condensation products of phenol and formaldehyde or acetaldehyde of the novolak resin-type.

Other polyepoxides that are in principle suitable for use herein are the polyglycidyl ethers of polyalcohols or diamines. Such polyglycidyl ethers are derived from polyalcohols, such as ethylene glycol, diethylene glycol, triethylene glycol, 1,2-propylene glycol, 1,4-butylene glycol, triethylene glycol, 1,5-pentanediol, 1,6-hexanediol or trimethylolpropane.

Still other polyepoxides are polyglycidyl esters of polycarboxylic acids, for example, reaction products of glycidol or epichlorohydrin with aliphatic or aromatic polycarboxylic acids, such as oxalic acid, succinic acid, glutaric acid, terephthalic acid or a dimeric fatty acid.

And still other epoxides are derived from the epoxidation products of olefinically-unsaturated cycloaliphatic compounds or from natural oils and fats.

One commercially available epoxy resin, EPON 2005, has a melting point of 120° C., and thus is suitable for use when the injection temperature for the thermosetting matrix resin is in the range of 90° C. to 110° C. However, at this injection temperature, another commercially available epoxy resin, EPON 1009F would not be suitable since it has a melting point of about 80° C.

The thermosetting resin may also be a benzoxazine, such as is described herein in connection with the thermosetting matrix resin.

The thermoplastic resin may be a polyether sulfone (“PES”), whose Tg is about 200° C. PES is available commercially from ICT and Sumitomo, for instance. Another thermoplastic resin is polypropylene oxide, which may be useful herein. Desirably, the toughening binder composition embraces the combination of an epoxy resin and a polyether sulfone.

The toughening binder composition embraces the combination of the thermosetting resin of the toughening binder composition and the thermoplastic resin of the toughening binder composition in a 10:1 to 1:20 by weight ratio, such as a 1:5 to 1:10 by weight ratio. Desirably, as noted above in the preceding paragraph, the thermosetting resin is an epoxy resin and the thermoplastic resin is a polyether sulfone in a 1:10 by weight ratio.

The thermoplastic resin of the toughening binder composition should have a nominal particle size in the range of 10 um to 100 um. The thermosetting resin of the toughening binder composition should have a nominal particle size in the range of 1 um to 100 um.

The toughening binder composition may take a form selected from powder, liquid dispersion or suspension, fiber, fleece or oriented mat and film.

The thermoplastic resin of the toughening binder composition desirably is functionalized with a reactive group. For instance, the functionalized thermoplastic resin of the toughening binder composition is reactive with either or both of the thermosetting resin or the thermosetting matrix resin at a temperature greater than the melting point of the thermosetting resin and less than or equal to the cure temperature of the thermosetting matrix resin. A functionalized PES may have a reaction temperature in the vicinity of 150° C.

The following examples will help further illustrate the present invention.

### EXAMPLE

In this example, a formulation suitable for use as a RTM resin is illustrated together with the preform and the inventive toughening binder composition.

### 1. Thermosetting Matrix Resin

Two thermosetting matrix resins are illustrated below in Table 1, and are referred to as MR 1 and MR 2.

TABLE 1

| | |
|---|---|
| Component | Commercial |

| Type | Identity | Source | MR 1 | MR 2 |
|---|---|---|---|---|
| Benzoxazine | V/mono- | Henkel | 75 | 75 |
| | functional | | | |
| | benzoxazine | | | |
| Epoxy | CY179 | Huntsman | 25 | 7 |
| | EPON 825 | Hixon | | 18 |

### 2. Thermosetting Matrix Resin Mixing Process

The benzoxazine was heated at a temperature of 160-180° F. to render it in a fluid state. The epoxy was mixed into the benzoxazine at a temperature of 180° F. until a homogeneous mixture was observed. Vacuum was applied to the mixture at a temperature of 180° F. for a period of time of 30-60 minutes, until no bubbling was observed. The degassed mixture was stored in a closed can at room temperature.

### 3. Toughening Binder Composition

Two toughening binder compositions are illustrated below in Table 2, and are referred to as TB 1 and TB 2.

TABLE 2

| | |
|---|---|
| Component | Commercial |

| Type | Identity | Source | TB 1 | TB 2 |
|---|---|---|---|---|
| Epoxy | EPON 2005 | Hixon | 1 | 1 |
| PES | PES 5003P | Sumitomo | 5 | 10 |

The weight of the toughening binder composition is 8% of the total fiber weight. The toughening binder composition was prepared by mixing together the epoxy and PES, and thereafter applying it uniformly onto fabric surface. The preform was prepared by heating the fabric [AU 072-1, HTS 5631, 12K, 290 gsm (commercially available from ECC Fabrics)] at a temperature of 250° F. for a period of time of 30 minutes.

### 4. RTM Process

The injection temperature was 230° F., and the cure schedule was 2 hours at a temperature of 365° F.

### 5. Results

The results of the RTM process on MR2 and TB1 are illustrated below in Table 3.

TABLE 3

| Cured Laminate Properties | Values |
|---|---|
| ILSS, tested @ RT, ksi | 12 |
| ILSS, tested @ 250° F., ksi | 8.9 |
| OHC, ksi | 48 |
| Compression, 0°, ksi | 172 |
| CAI, ksi | 36 |
| DMTA dry, ° F. | 367 |
| DMTA H/W, ° F. | 320 |

1. A composition of matter comprising:
a. a thermosetting matrix resin; and
b. a preform comprising a plurality of fabric plies or unidirectional plies disposed between which is a toughening binder composition comprising the combination of a thermosetting resin and a thermoplastic resin,
wherein the thermosetting resin:
i. has a melting point that is greater than the temperature at which the thermosetting matrix resin infuses the preform and
ii. is less than the cure temperature of the thermosetting resin matrix, and
wherein the thermoplastic resin has a Tg that is equal to or greater than the melting point of the thermosetting resin.

2. The composition of claim 1, wherein the thermosetting matrix resin comprises a benzoxazine.

3. The composition of claim 1, wherein the toughening binder composition comprises the combination of an epoxy resin and a polyether sulfone.

4. The composition of claim 1, wherein the thermosetting resin of the toughening binder composition is an epoxy resin.

5. The composition of claim 1, wherein the thermoplastic resin of the toughening binder composition is a polyether sulfone.

6-8. (canceled)

9. The composition of claim 1, wherein the thermoplastic resin of the toughening binder composition has a nominal particle size in the range of 10 um to 100 um.

10. The composition of claim 1, wherein the thermosetting resin of the toughening binder composition has a nominal particle size in the range of 1 um to 100 um.

11. The composition of claim 1, wherein the toughening binder composition is in a form selected from the group consisting of powder, liquid dispersion or suspension, fiber, fleece or oriented mat and film.

12. The composition of claim 1, wherein the thermoplastic resin of the toughening binder composition is functionalized with a reactive group.

13. (canceled)

14. A resin transfer molding process, steps of which comprise:
(a) providing a heat curable composition into a closed mold containing a preform comprising a plurality of fabric plies or unidirectional plies disposed between which is a toughening binder composition comprising the combination of a thermosetting resin and a thermoplastic resin,
wherein the thermosetting resin:
i. has a melting point that is greater than the temperature at which the thermosetting matrix resin infuses the preform and
ii. is less than the cure temperature of the thermosetting resin matrix, and
wherein the thermoplastic resin has a Tg that is equal to or greater than the melting point of the thermosetting resin;
(b) exposing the interior of the mold to a first elevated temperature and elevated pressure sufficient to wet the preform with the heat curable composition; and
(c) curing the heat curable composition-impregnated preform within the mold at a second elevated temperature to form a resin transfer molded product, wherein the heat curable composition comprises (i) a benzoxazine component.

15. A vacuum assisted resin transfer molding process, steps of which comprise:
(a) providing a preform into a mold, wherein the preform comprises a plurality of fabric plies or unidirectional plies disposed between which is a toughening binder composition comprising the combination of a thermosetting resin and a thermoplastic resin,
wherein the thermosetting resin:
i. has a melting point that is greater than the temperature at which the thermosetting matrix resin infuses the preform and
ii. is less than the cure temperature of the thermosetting resin matrix, and
wherein the thermoplastic resin has a Tg that is equal to or greater than the melting point of the thermosetting resin;
(b) providing a heat curable composition into the mold under a first elevated temperature and under vacuum for a time sufficient to allow the composition to wet the preform; and
(c) exposing the mold containing the composition wetted-preform to a second elevated temperature while under vacuum sufficient to cure the heat curable composition-wetted preform within the mold to form a resin transfer molded product, wherein the heat curable composition comprises (i) a benzoxazine component.

16. (canceled)

17. A vacuum assisted resin transfer molding preform comprising:
(a) a plurality of fabric plies or unidirectional plies disposed between which is (b) a toughening binder composition comprising the combination of a thermosetting resin and a thermoplastic resin,
wherein the thermosetting resin:
i. has a melting point that is greater than the temperature at which the thermosetting matrix resin infuses the preform and
ii. is less than the cure temperature of the thermosetting resin matrix, and
wherein the thermoplastic resin has a Tg that is equal to or greater than the melting point of the thermosetting resin.

18. A resin film infusion process, steps of which comprise:
(a) providing a preform into a closed mold containing a heat curable composition in film form, wherein the preform comprises a plurality of fabric plies or unidirectional plies disposed between which is a toughening binder composition comprising the combination of a thermosetting resin and a thermoplastic resin,
wherein the thermosetting resin:
i. has a melting point that is greater than the temperature at which the thermosetting matrix resin infuses the preform and
ii. is less than the cure temperature of the thermosetting resin matrix, and
wherein the thermoplastic resin has a Tg that is equal to or greater than the melting point of the thermosetting resin;
(b) exposing the interior of the mold to a first elevated temperature and optionally vacuum, while the exterior of the mold is exposed to an elevated pressure, for a time sufficient to infuse the preform with the heat curable composition; and
(c) curing the heat curable composition-infused preform within the mold at a second elevated temperature to form a resin film infused product, wherein the heat curable composition comprises (i) a benzoxazine component.
